(19) United States
(12) Patent Application Publication
(10) Pub. No.: US 2011/0141616 A1
(43) Pub. Date: Jun. 16, 2011

(54) MAGNETIC RECORDING HEAD AND MAGNETIC DISK STORAGE DEVICE

(75) Inventors: Ikuya Tagawa, Hiratsuka-shi (JP); Masafumi Mochizuki, Chigasaki-shi (JP); Yohji Maruyama, Iruma-shi (JP)

(73) Assignee: Hitachi Global Storage Technologies Netherlands B.V., Amsterdam (NL)

(21) Appl. No.: 12/965,332

(22) Filed: Dec. 10, 2010

(30) Foreign Application Priority Data
Dec. 11, 2009 (JP) 2009-281699

(51) Int. Cl. G11B 5/265; G11B 21/02

(52) U.S. Cl. 360/75; 360/121; G9B/5.068; G9B/21.003

(57) ABSTRACT

In one embodiment, a magnetic recording head includes a main magnetic pole adapted for generating a magnetic field for recording information on a magnetic disk, a magnetic shield member adapted for suppressing spreading of a magnetic field output from the main magnetic pole through a non-magnetic insulation member, a side top gap, a side bottom gap, and a trailing gap. The side top gap is less than two times the trailing gap, the side bottom gap is larger than the side top gap, and the magnetic shield member is positioned on a sliding surface of the magnetic recording head and includes a trailing portion positioned adjacent the trailing gap in the trailing direction and at least one side portion positioned adjacent the side bottom gap in the cross-track direction. Other heads and systems are also presented according to various embodiments.

### RELATED APPLICATIONS

The present application claims priority to a Japanese Patent Application filed Dec. 11, 2009 under Appl. No. 2009-281699, which is incorporated herein by reference.

### FIELD OF THE INVENTION

The present invention relates to a magnetic recording head and a magnetic disk storage device.

### BACKGROUND OF THE INVENTION

Over the past few years, in the field of information technology, attention is being paid to improving the processing speed of central processing units (CPUs) and increasing the storage capacity of storage devices. In this case, the magnetic disk storage device is most often used as a high-capacity storage device, and research has been conducted on achieving higher speeds and higher densities. One recording method for storing information on a magnetic disk storage device is longitudinal magnetic recording which generates a magnetic field parallel to the recording surface of the magnetic recording medium. Another recording method is perpendicular magnetic recording which generates a magnetic field perpendicular to the recording surface of the magnetic recording medium. However, the perpendicular magnetic recording method dominates in usage because of the demands for higher density recording devices.

In order to achieve a high recording density, the perpendicular magnetic recording method provides a higher line density which is the density in the circumferential direction of a magnetic disk which is the recording direction, and a higher track density which is the density in the radial direction of the magnetic disk perpendicular to the recording direction. In order to improve the track density, an erase band which is the area affected by writes to mutually adjacent tracks of the magnetic disk must be narrowed. In order to narrow the erase band, the magnetic field gradient in the track width direction of the magnetic field output by the magnetic recording head must be increased, and the head-fringe magnetic field interference, hereinafter, referred to as adjacent track interference (ATI), which is the extent that interference with adjacent tracks must be reduced.

For magnetic recording heads, generally, the effect on adjacent tracks due to the skew angle produced by the swiveling motion of the suspension arm is considered, and therefore triangular or trapezoidal main pole shapes, as seen from the air bearing surface (ABS), are adopted. For example, refer to Japanese Unexamined Patent Appl. Pub. No. 2006-114159, Japanese Unexamined Patent Appl. Pub. No. 2007-257711, Japanese Unexamined Patent Appl. Pub. No. 2008-198326, Japanese Unexamined Patent Appl. Pub. No. 2009-16024, and Japanese Unexamined Patent Appl. Pub. No. 2009-116952. In addition, a single-pole recording method has been proposed as a technique for greatly increasing the track density, such as described in U.S. Pat. No. 6,967,810. The single-pole recording method records while the recording tracks overlap similar to the tiles on a roof. Consequently, the recorded information in the center portion of the track is always overwritten, and only the recorded information at the ends of the track is read out.

All of the examples in the prior art described above are useful. However, tests on the relationship between the intervals (gaps) of the main magnetic pole and the magnetic shield of the magnetic recording head and the fringe magnetic field interference of the magnetic recording head are still insufficient.

Furthermore, in a single-pole recording method, a reduction in the erase band is essential because the recorded information at the track ends is used in a read out, as described earlier.

### SUMMARY OF THE INVENTION

According to one embodiment, a magnetic recording head includes a main magnetic pole adapted for generating a magnetic field for recording information on a magnetic disk, a magnetic shield member adapted for suppressing spreading of a magnetic field output from the main magnetic pole through a non-magnetic insulation member, a side top gap defined as a distance in a cross-track direction between the main magnetic pole and the magnetic shield member at a trailing end of the main magnetic pole on either side of the main magnetic pole, a side bottom gap defined as a distance in the cross-track direction between the main magnetic pole and the magnetic shield member at a leading end of the main magnetic pole on either side of the main magnetic pole, and a trailing gap defined as a distance in a trailing direction between the main magnetic pole and the magnetic shield member. The magnetic shield member is positioned on a sliding surface of the magnetic recording head and includes a trailing portion positioned adjacent the trailing gap in the trailing direction and at least one side portion positioned adjacent one of the side bottom gaps in the cross-track direction. Also, the side top gap is less than two times a distance of the trailing gap and the side bottom gap is larger than the side top gap.

In another embodiment, a system includes a magnetic disk and a magnetic recording head for recording information to the magnetic disk. The magnetic recording head includes a main magnetic pole adapted for generating a magnetic field for recording information on a magnetic disk, a magnetic shield member adapted for suppressing spreading of a magnetic field output from the main magnetic pole through a non-magnetic insulation member, a side top gap defined as a distance in a cross-track direction between the main magnetic pole and the magnetic shield member at a trailing end of the main magnetic pole on either side of the main magnetic pole, a side bottom gap defined as a distance in the cross-track direction between the main magnetic pole and the magnetic shield member at a leading end of the main magnetic pole on either side of the main magnetic pole, and a trailing gap defined as a distance in a trailing direction between the main magnetic pole and the magnetic shield member. The magnetic shield member is positioned on a sliding surface of the magnetic recording head and includes a trailing portion positioned adjacent the trailing gap in the trailing direction and one side portion positioned adjacent one of the side bottom gaps and one of the side top gaps on a common side of the main magnetic pole in the cross-track direction. Also, the side top gap is less than two times a distance of the trailing gap and the side bottom gap is larger than the side top gap.

According to another embodiment, a system includes a magnetic disk and a magnetic recording head for recording information to the magnetic disk. The magnetic recording head includes a main magnetic pole adapted for generating a magnetic field for recording information on a magnetic disk, a magnetic shield member adapted for suppressing spreading of a magnetic field output from the main magnetic pole through a non-magnetic insulation member, a side top gap defined as a distance in a cross-track direction between the main magnetic pole and the magnetic shield member at a trailing end of the main magnetic pole on either side of the main magnetic pole, a side bottom gap defined as a distance in the cross-track direction between the main magnetic pole and the magnetic shield member at a leading end of the main magnetic pole on either side of the main magnetic pole, and a trailing gap defined as a distance in a trailing direction between the main magnetic pole and the magnetic shield member. The magnetic shield member is positioned on a sliding surface of the magnetic recording head and includes a trailing portion positioned adjacent the trailing gap in the trailing direction and two side portions positioned adjacent both side bottom gaps and both side top gaps in the cross-track direction. Also, the side top gap is less than two times the trailing gap and the side bottom gap is larger than the side top gap.

Any of these embodiments may be implemented in a magnetic data storage system such as a disk drive system, which may include a magnetic head, a drive mechanism for passing a magnetic storage medium (e.g., magnetic hard disk) over the head, and a control unit electrically coupled to the head for controlling operation of the head.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a schematic view showing the appearance of the air bearing surface (ABS) of the magnetic recording head related to a comparative example.

FIG. 2 is a graph of the distribution of the effective recording magnetic field in the magnetic recording head shown in FIG. 1, according to one embodiment.

FIG. 3 is a graph showing the changes in the gradient in the cross-track direction of the effective recording magnetic field when the side top gap is varied, according to one embodiment.

FIG. 4 is a graph showing the changes in the head fringe magnetic field when the side bottom gap is varied, according to one embodiment.

FIG. 5 is a perspective view of the magnetic disk storage device, according to Embodiment 1.

FIG. 6 is a schematic view showing the cross-sectional plane of the magnetic head slider of the magnetic disk storage device in FIG. 5, according to one embodiment.

FIG. 7 is a schematic view showing the ABS near the main magnetic pole of the magnetic recording head of the magnetic head slider in FIG. 6, according to one embodiment.

FIG. 8 is a graph of the distribution of the effective recording magnetic field of the magnetic recording head shown in FIG. 7, according to one embodiment.

FIG. 9 is a schematic view showing the ABS near the main magnetic pole of the magnetic recording head, according to Embodiment 2.

FIG. 10 is a schematic view showing the ABS near the main magnetic pole of the magnetic recording head, according to Embodiment 3.

### DETAILED DESCRIPTION

The following description is made for the purpose of illustrating the general principles of the present invention and is not meant to limit the inventive concepts claimed herein. Further, particular features described herein may be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

According to one general embodiment, a magnetic recording head includes a main magnetic pole adapted for generating a magnetic field for recording information on a magnetic disk, a magnetic shield member adapted for suppressing spreading of a magnetic field output from the main magnetic pole through a non-magnetic insulation member, a side top gap defined as a distance in a cross-track direction between the main magnetic pole and the magnetic shield member at a trailing end of the main magnetic pole on one side of the main magnetic pole, a side bottom gap defined as a distance in the cross-track direction between the main magnetic pole and the magnetic shield member at a leading end of the main magnetic pole on one side of the main magnetic pole, and a trailing gap defined as a distance in a trailing direction between the main magnetic pole and the magnetic shield member. The magnetic shield member is positioned on a sliding surface of the magnetic recording head and includes a trailing portion positioned adjacent the trailing gap in the trailing direction and at least one side portion positioned adjacent the side bottom gap in the cross-track direction. Also, the side top gap is less than two times the distance of the trailing gap and the side bottom gap is larger than the side top gap.

In another general embodiment, a system includes a magnetic disk and a magnetic recording head for recording information to the magnetic disk. The magnetic recording head includes a main magnetic pole adapted for generating a magnetic field for recording information on a magnetic disk, a magnetic shield member adapted for suppressing spreading of a magnetic field output from the main magnetic pole through a non-magnetic insulation member, a side top gap defined as a distance in a cross-track direction between the main magnetic pole and the magnetic shield member at a trailing end of the main magnetic pole on one side of the main magnetic pole, a side bottom gap defined as a distance in the cross-track direction between the main magnetic pole and the magnetic shield member at a leading end of the main magnetic pole on one side of the main magnetic pole, and a trailing gap defined as a distance in a trailing direction between the main magnetic pole and the magnetic shield member. The magnetic shield member is positioned on a sliding surface of the magnetic recording head and includes a trailing portion positioned adjacent the trailing gap in the trailing direction and one side portion positioned adjacent the side bottom gap and one of the side top gaps on a common side of the main magnetic pole in the cross-track direction. Also, the side top gap is less than two times the distance of the trailing gap and the side bottom gap is larger than the side top gap.

According to another general embodiment, a system includes a magnetic disk and a magnetic recording head for recording information to the magnetic disk. The magnetic recording head includes a main magnetic pole adapted for generating a magnetic field for recording information on a magnetic disk, a magnetic shield member adapted for suppressing spreading of a magnetic field output from the main magnetic pole through a non-magnetic insulation member, a side top gap defined as a distance in a cross-track direction between the main magnetic pole and the magnetic shield member at a trailing end of the main magnetic pole on either side of the main magnetic pole, a side bottom gap defined as a distance in the cross-track direction between the main magnetic pole and the magnetic shield member at a leading end of the main magnetic pole on either side of the main magnetic pole, and a trailing gap defined as a distance in a trailing direction between the main magnetic pole and the magnetic shield member. The magnetic shield member is positioned on a sliding surface of the magnetic recording head and includes a trailing portion positioned adjacent the trailing gap in the trailing direction and two side portions positioned adjacent both side bottom gaps and both side top gaps in the cross-track direction. Also, the side top gap is less than two times the trailing gap and the side bottom gap is larger than the side top gap.

A magnetic recording head, according to one embodiment, advances in the leading direction with respect to a rotating magnetic disk and records data on the magnetic disk, and is provided with a main magnetic pole which generates the magnetic field for recording information on the magnetic disk, and a magnetic shield member which suppresses the spread of the magnetic field output from the main magnetic pole through a non-magnetic insulation member. The magnetic shield member is positioned on a sliding surface, which is a surface opposite the magnetic disk, and includes at least one side of the trailing direction which is a direction opposite to the leading direction from the main magnetic pole and the cross-track direction which is the track width direction of the magnetic disk. A side top gap is the distance in the cross-track direction between the main magnetic pole and the magnetic shield member at the end in the trailing direction of the main magnetic pole and is less than about 2 times the trailing gap which is the distance in the trailing direction between the main magnetic pole and the magnetic shield member. A side bottom gap is the distance in the cross-track direction between the main magnetic pole and the magnetic shield member at the end in the leading direction of the main magnetic pole and is larger than the side top gap.

In the magnetic recording head, according to one embodiment, the side top gap may have about the same size as the trailing gap. Here, the “same size” includes a range of about greater than or less than about 20%.

In another embodiment, the side bottom gap may be less than about two times a pole width, which is defined as a width of the main magnetic pole at the trailing end thereof in the cross-track direction.

In another embodiment, the magnetic shield member may be characterized by an aperture width of the magnetic shield member horizontally adjacent with the leading end of the main magnetic pole being larger than an aperture width of the magnetic shield member horizontally adjacent with the trailing end of the main magnetic pole. For example, the magnetic shield member may be formed into a concave shape by forming both sides in the cross-track direction of the main magnetic pole.

In a further embodiment, a sidewall of the magnetic shield member facing the main magnetic pole may taper away from a vertical line bisecting the main magnetic pole from a trailing end of the sidewall to a leading end of the sidewall and may be characterized by an aperture width of the magnetic shield member horizontally adjacent with the leading end of the main magnetic pole being larger than an aperture width of the magnetic shield member horizontally adjacent with the trailing end of the main magnetic pole.

In a further example, a trailing portion of the magnetic shield member may be positioned adjacent the trailing gap in the trailing direction and two side portions of the magnetic shield member may be positioned facing each side of the main magnetic pole in a cross-track direction.

According to yet another embodiment, the magnetic shield member may have a non-uniform thickness across the cross-track direction characterized by an approximately L-shape as viewed normal to the sliding surface, and a width of a portion of the magnetic shield member laterally adjacent to the trailing end of the main magnetic pole may be larger than a recording track width.

For example, the magnetic shield member may be formed into an approximately L-shape by forming only one side in the cross-track direction of the main magnetic pole. The pole width may be larger than the recording track width to avoid overwriting tracks. In a further example, a trailing portion of the magnetic shield member may be positioned adjacent the trailing gap in the trailing direction and a side portion of the magnetic shield member may be positioned facing one side of the main magnetic pole in the cross-track direction.

In a further embodiment, the magnetic shield member may have a non-uniform thickness characterized by a portion of the magnetic shield member on one side of the main magnetic pole being below the side bottom gap while another portion of the magnetic shield member on an opposite side of the main magnetic pole being above the side top gap, and a width of the magnetic shield member at the trailing end of the main magnetic pole may be larger than a recording track width.

A magnetic disk storage device, according to one embodiment, may comprise any of the magnetic recording heads described above along with a magnetic disk which records data via the magnetic recording head.

For example, a magnetic data storage system may include at least one magnetic recording head as described according to any embodiment, a magnetic recording disk, a drive mechanism for rotating the magnetic disk across the at least one magnetic recording head, and a controller coupled to the at least one magnetic recording head for controlling operation of the at least one magnetic recording head.

First, a comparative example for obtaining specifications of the magnetic recording head according to various embodiments is explained below.

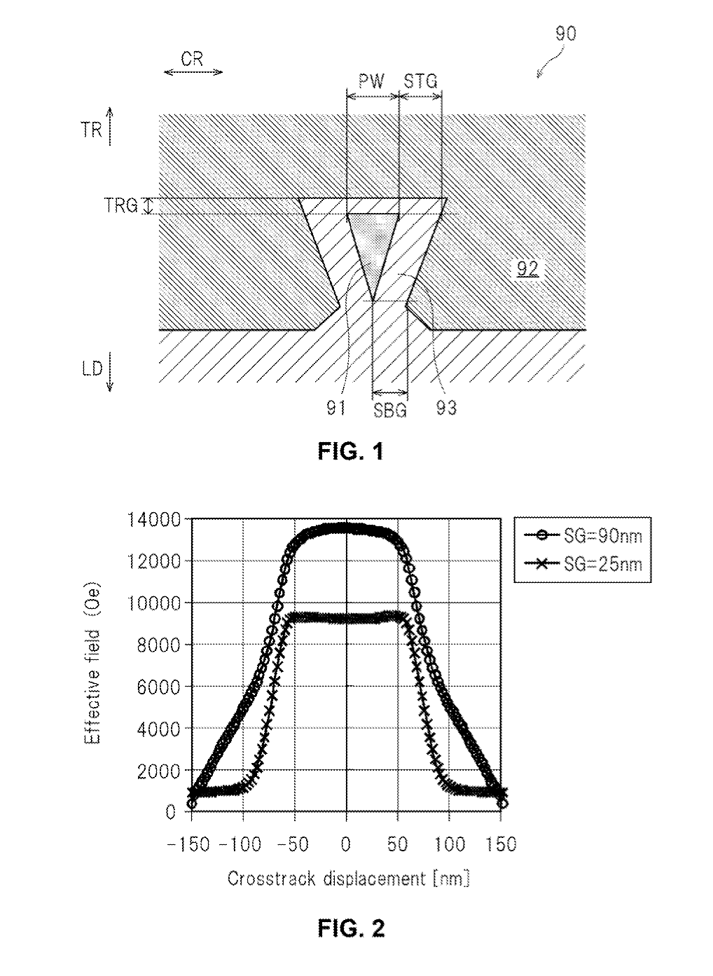

In a comparative example, a magnetic recording head 90 is presented that may be compared to embodiments described herein. FIG. 1 shows a schematic view of the appearance of the disk sliding surface, which is hereinafter referred to as the air bearing surface (ABS) of the magnetic recording head 90. The descriptions herein describe members being on the sliding surface. However, according to various embodiments, the sliding surface may be covered by other layers, such as a conventional hard protective layer, a lubricating layer, etc., but will still be referred to as the sliding surface for purposes of these descriptions. In FIG. 1, which shows the ABS, a main magnetic pole 91 which outputs a magnetic field for recording to a magnetic disk, a magnetic shield 92 and a non-magnetic insulation film 93 are shown. When viewed from the rotating magnetic disk, the downward direction in the drawing is the leading direction LD which is the direction of the advance of the magnetic head slider. The upward direction in the drawing is the trailing direction TR. The width at the end on the trailing direction TR side of the main magnetic pole 91 is the pole width PW. The width of the non-magnetic insulation film 93 on the trailing direction side of the main magnetic pole 91 is the trailing gap TRG. The width of the non-magnetic insulation film 93 in the cross-track direction CR (track width direction of the magnetic disk) at the end in the trailing direction of the main magnetic pole 91 is the side top gap STG. The width of the non-magnetic insulation film 93 in the cross-track direction CR at the leading end of the main magnetic pole 91 is the side bottom gap SBG. FIG. 1 shows an example of the gap (hereinafter, simply referred to as the side gap SG) which has the same size as the side top gap STG and the side bottom gap SBG.

FIG. 2 is a graph showing the distribution in the cross-track direction CR when the side gap SG is 90 nm and when the side gap is about 25 nm for the effective recording magnetic field calculated by the finite element method for the magnetic recording head 90 which has the widths of the non-magnetic insulation film 93 as shown in FIG. 1. The sizes of the gaps other than the side gap SG are not changed, and the track width which is the region to be recorded is about ±50 nm. In this case, the erase band is formed near the cross-track position about ±70 nm to about 90 nm. When the side gap SG is decreased to about 25 nm, the effective recording magnetic field on the outside of the track width becomes smaller, and the ATI at the erase band formation position is improved substantially. On the other hand, the magnetic field strength in the center of the track decreases greatly from approximately 13,500 Oe to approximately 9300 Oe, and the magnetic field for recording to the track is insufficient.

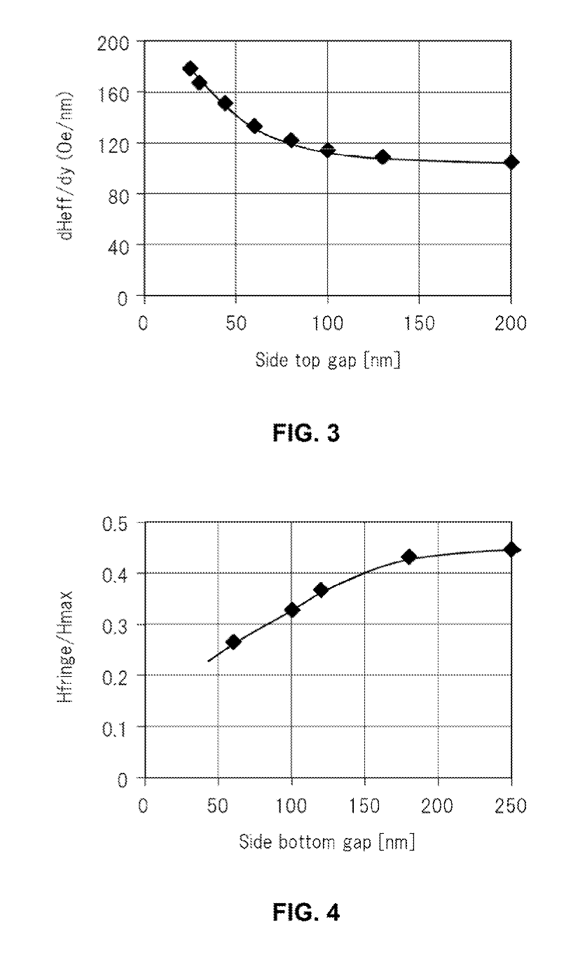

FIG. 3 is a graph showing the changes in the gradient (dHeff/dy) in the cross-track direction CR of the effective recording magnetic field when the side top gap STG is varied. The simulation plots the maximum value of the gradient calculated by the finite element method when the trailing gap TRG is set to about 25 nm, the pole width PW to about 60 nm, and the side bottom gap SBG to about 80 nm. However, when the side top gap STG is at least about 80 nm, the side bottom gap SBG is set to the same value as the side top gap STG. In addition, the length (flare height) from the ABS to the position of the main magnetic pole narrowing (flare) is adjusted so that the magnetic field strength does not degrade.

The erase band depends on the gradient of the recording magnetic field output by the main magnetic pole 91 in the cross-track direction CR. Specifically, the erase band decreases as the gradient in the cross-track direction CR of the effective recording magnetic field increases.

As shown in FIG. 3, in a region where the side top gap STG is no more than about two times the trailing gap TRG, namely no more than about 50 nm, the gradient in the cross-track direction CR of the effective recording magnetic field increases abruptly even for a minute decrease in the gap. On the other hand, in a region where the side top gap STG is greater than about 50 nm, the change in the cross-track gradient is small even for an extremely large side top gap STG. Thus, in order to obtain the effect of an abrupt increase in the cross-track gradient, the side top gap STG should be narrower than about two times the trailing gap TRG. In addition, because the gradient is particularly large in a region where the side top gap STG is no more than about 37 nm, preferably, the side top gap STG may be less than about 1.5 times the trailing gap TRG.

Theoretically, the density of magnetic force lines output from the main magnetic pole 91, e.g., the magnetic field strength, becomes stronger as the gap with the shield placed opposite the main magnetic pole decreases, and becomes weaker as the gap increases. The known theory is that there is always a large total number of magnetic force lines reaching the interior of the recording medium when the gap described above is small. In other words, the magnetic field is strong. In addition, the change with respect to the position of the magnetic field, that is, the gradient of the magnetic field in the medium, becomes larger as the gap becomes smaller. Generally, the trailing gap of the magnetic head is designed so that the magnetic field gradient becomes the maximum in the range where the magnetic field strength in the medium is not damaged.

A desired effect, according to one embodiment, is to have the same design for the side top gap as the design of the trailing gap because the fringe magnetic field in the cross-track direction near the side top gap decreases, and the magnetic field gradient increases. Preferably, the trailing gap TRG and the side top gap STG may have the same size. As shown in FIG. 3, if the side top gap STG is about 20 nm to about 30 nm, it is believed that a major effect similar to having the same size as the trailing gap TRG may be obtained. Therefore, if a range of the size of the trailing gap TRG is about ±20% that of the side top gap STG, the range is within in the meaning of the “same size,” as used herein.

FIG. 4 is a graph showing the change in the head fringe magnetic field when the side bottom gap SBG is varied, according to some embodiments. In the simulation, the calculated positions of the fringe magnetic field are calculated by the finite element method at the position about 60 nm from the center part of the track and a head skew of about 0° where the trailing gap TRG is set to about 25 nm, the pole width PW to 60 nm, and the side top gap STG to about 25 nm, in one approach. By varying the side bottom gap SBG, the maximum magnetic field in the center part of the pole also changes and is plotted as the ratio of the fringe magnetic field and the maximum magnetic field.

If the side bottom gap SBG widens, the effective recording magnetic field in the center part of the track, namely, the center part of the pole, may strengthen. However, when the side bottom gap SBG is too wide, the head fringe magnetic field interference in adjacent tracks may no longer be neglected.

As shown in FIG. 4, in a region where the side bottom gap SBG is no more than about two times the pole width, that is no more than about 120 nm, the ratio of the fringe magnetic field decreases in response to the decrease in the gap. However, in a gap region greater than about 120 nm, the ratio of the fringe magnetic field hardly changes at all. This indicates a small change in the fringe magnetic field in a region where the side bottom gap SBG is sufficiently wider because the observed position of the fringe magnetic field is about 60 nm. In one embodiment, to prevent this type of worsening of the fringe magnetic field, the side bottom gap SBG may be narrower than about two times the pole width PW. In addition, the side bottom gap SBG is more preferably smaller than about 1.5 times the pole width because the fringe magnetic field ratio is particularly small in a region where the side bottom gap SBG is less than 90 nm, in a further approach.

One embodiment (Embodiment 1) based on the comparative example described above, is described below.

Embodiment 1 is described with reference to the drawings. In the descriptions and the drawings of Embodiments 1 to 3 below, the same reference numbers are assigned to the same or similar elements, and duplicate descriptions are omitted.

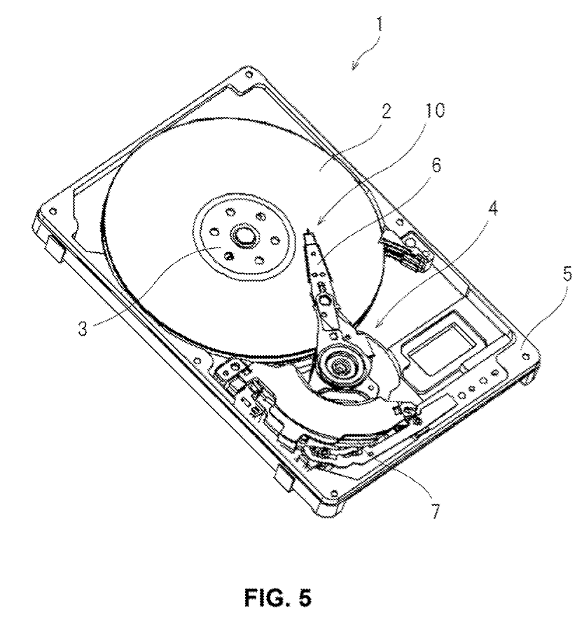

FIG. 5 is a perspective view of a magnetic disk storage device 1 related to one embodiment. In FIG. 5, the illustration of the top cover is omitted, and the mechanism accommodated in the cabinet 5 is shown. The mechanism of the magnetic disk storage device 1 comprises a magnetic disk 2 which records binary data based on the difference in the direction of magnetization, a spindle motor 3 for rotating the magnetic disk 2, and a head assembly 4 which is the mechanism for writing to the magnetic disk 2. Furthermore, the head assembly 4 is provided with a magnetic head slider 10 which writes to the magnetic disk 2, a suspension arm 6 for holding the magnetic head slider 10 at the front end, a voice coil motor 7 which drives the swiveling of the suspension arm 6 at the back end of the suspension arm 6 and moves the magnetic head slider 10 roughly in the radial direction of the magnetic disk 2 to guide the arm to the data read/write position, and a controller, which may be an integrated circuit, which is not shown, for controlling the operation of these elements.

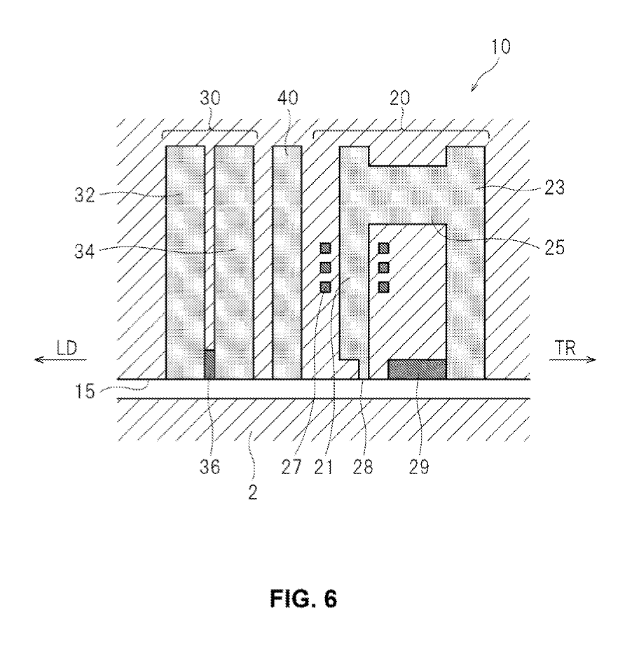

FIG. 6 is a schematic view of the cross-section of the magnetic head slider 10. In this drawing, the left side of the figure is the leading direction LD which is the advance direction of the magnetic head slider 10 when viewed from the rotating magnetic disk 2. The right side of the figure is the trailing direction TR. As shown in the figure, the magnetic head slider 10 comprises a recording head (magnetic recording head) 20, a playback head 30, and a magnetic shield 40 for separating the other parts which are formed in a non-magnetic insulation film member, which may be formed from a material such as alumina, in some approaches. The ABS 15 receives the air flow generated by the rotation of the magnetic disk 2 during operation and floats above the magnetic disk 2.

The recording head 20 may be a single magnetic pole recording head which implements perpendicular magnetic recording. The recording head 20 has a main magnetic pole 21, an auxiliary magnetic pole 23, and a connector 25 which comprise soft magnetic materials, such as NiFe alloy in one approach, and are magnetically connected. The head 20 also includes a coil 27 wound around the periphery of the main magnetic pole 21, and a magnetic shield 29 which is formed in the periphery of the main magnetic pole 21 near the ABS 15, which may comprise, for example, NiFe alloy in one approach.

The coil 27 excites the main magnetic pole 21, and the recording magnetic field is output from the recording magnetic field output surface 28 which is the ABS of main magnetic pole 21. The output recording magnetic field passes through the recording layer (not shown) on the surface of the magnetic disk 2 and a soft magnetic layer (not shown), and again through a recording layer, and is absorbed by the auxiliary magnetic pole 23. The magnetic shield 29 is provided on the trailing direction TR side of the recording magnetic field output surface 28 to prevent the spread of the output recording magnetic field, in some embodiments.

A playback head 30 is positioned on the leading direction LD side of the recording head 20 and separated by the magnetic shield 40 in one embodiment. The playback head 30 has a playback element 36 comprising a current-perpendicular-to-plane giant magnetoresistive (CPP-GMR) effect element, an upper shield 32 on the leading direction LD side of the playback element 36, and a lower shield 34 on the trailing direction TR side of the playback element 36.

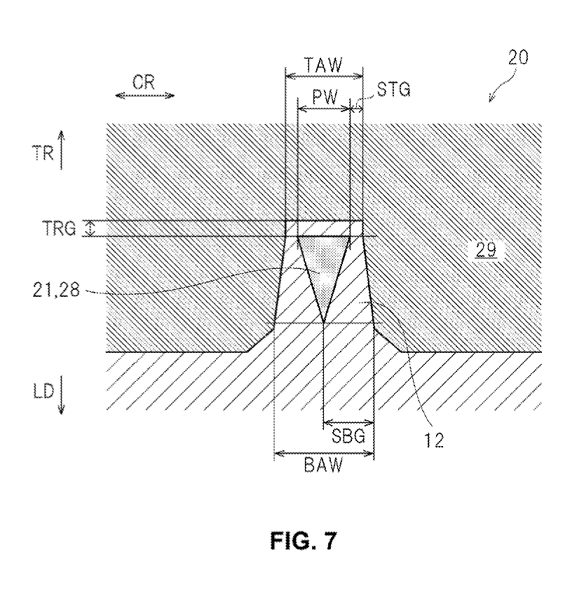

FIG. 7 is a schematic view of the ABS near the main magnetic pole 21, according to one embodiment. The downward direction in the drawing is the leading direction LD, and the upward direction is the trailing direction TR. The horizontal direction in the drawing is the cross-track direction CR, which is the track width direction of the magnetic disk 2. As shown in the drawing, the main magnetic pole 21 has a roughly isosceles triangular shape which comes to a fine point in the leading direction LD and prevents writing to adjacent tracks by the skew angle generated by the swiveling motion of the suspension arm 6. The magnetic shield 29 surrounds the main magnetic pole 21 with the non-magnetic insulation film 12 in between, and is formed in a concave shape opening in the leading direction LD, in one approach.

In this embodiment, the trailing gap TRG, which is the width of the magnetic shield 29 in the trailing direction TR of the main magnetic pole 21, may be about 25 nm. The side top gap STG, which is the distance in the cross-track direction CR between the main magnetic pole 21 and the magnetic shield 29, may be about 25 nm at the end in the trailing direction TR of the main magnetic pole 21. The side bottom gap SBG, which is the distance in the cross-track direction CR between the main magnetic pole 21 and the magnetic shield 29, may be about 80 nm at the end in the leading direction LD of the main magnetic pole 21.

In one embodiment, the side top gap STG is narrower than about two times the trailing gap TRG and becomes the same width as the trailing gap TRG. In addition, the side bottom gap SBG may be formed to be larger than the side top gap STG to hold more recording magnetic field in the center part of the main magnetic pole 21, and may be formed to be less than about two times the pole width PW when the width at the end on the trailing direction TR side of the main magnetic pole 21 is the same as the pole width PW. In addition, the bottom aperture width BAW of the magnetic shield 29 at the end in the leading direction LD of the main magnetic pole 21 may be formed to be larger than the top aperture width TAW of the magnetic shield 29 at the end in the trailing direction TR of the main magnetic pole 21, in one approach.

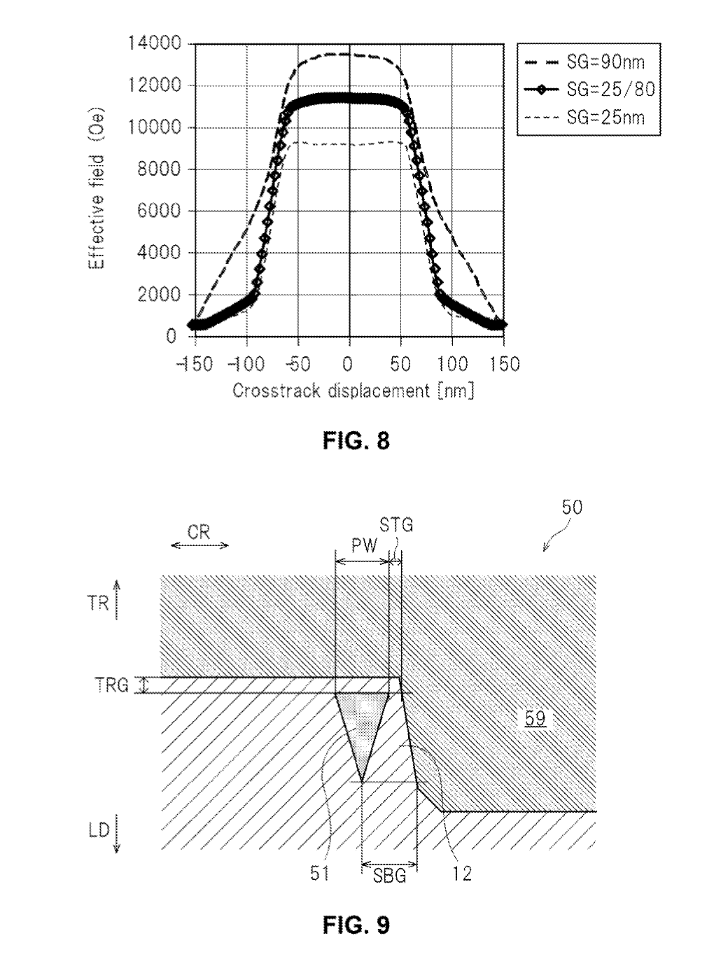

FIG. 8 is a graph showing the distribution in the cross-track direction CR for an effective recording magnetic field calculated by the finite element method by using the shape in FIG. 7. For comparison, two distributions for the conventional head shown in FIG. 2 are indicated by the dashed lines. The fringe magnetic field near the cross-track position about ±70-90 nm where the erase band is formed is substantially improved similar to the case where the side gap SG in FIG. 2 is about 25 mm. Furthermore, the magnetic field strength in the center part of the track is restored to approximately 115,000 Oe.

Consequently, according to the magnetic recording head and the magnetic disk storage device of this embodiment, the fringe magnetic field may be reduced without causing a decrease in the recording magnetic field.

In another embodiment (Embodiment 2), as shown in FIG. 9, which is a schematic view of the ABS near a main magnetic pole 51 related to a magnetic recording head 50 in Embodiment 2, the magnetic recording head 50 may be a magnetic recording head for single-pole recording where the pole width PW is wider than the recording track width. The only differences in this embodiment (Embodiment 2) from Embodiment 1 are in the main magnetic pole 51 and the magnetic shield 59. The other structures are the same or substantially similar, and the descriptions of the other structures are omitted for brevity.

In the single-pole recording method, the magnetic shield 59 is formed into an L shape, and the side top gap STG and the side bottom gap SBG are provided only on one side of the main magnetic pole 51 so that only the erase band on one side becomes smaller in order to record in one direction, and the adjacent track on one side is overlapped, according to one embodiment.

In this embodiment, the conditions described above may be applied to the trailing gap TRG, the side top gap STG, and the side bottom gap SBG as shown in FIG. 9. In this embodiment, the trailing gap TRG may be set to about 25 nm, the side top gap STG to about 25 nm, and the side bottom gap SBG to about 80 nm.

Consequently, according to the magnetic recording head and the magnetic disk storage device of this embodiment, the erase band width and the fringe magnetic field may be decreased without lowering the recording magnetic for a magnetic disk using the single-pole recording method.

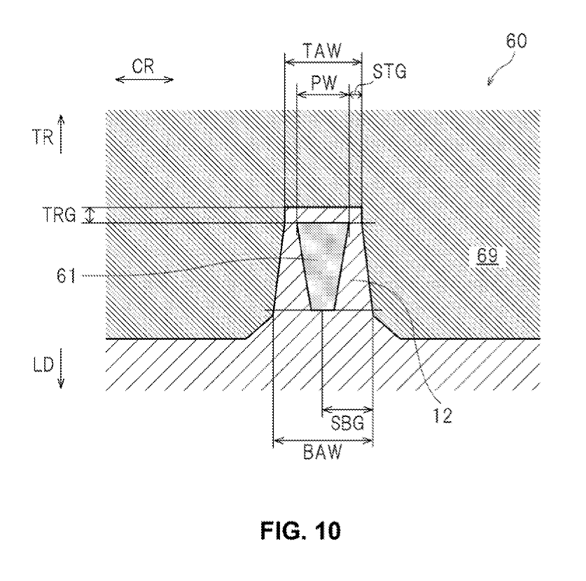

A magnetic recording head 60 in Embodiment 3 is shown in FIG. 10, which is a schematic view of the ABS near a main magnetic pole 61. In Embodiment 1 and Embodiment 2, the shape of the main magnetic pole had a roughly isosceles triangular shape, but the shape of the main magnetic pole 61 in the magnetic recording head 60 related to this embodiment has a trapezoidal shape. In this case, the distance between the main magnetic pole and the magnetic shield on the extended line on the long base edge of the trapezoid of the main magnetic pole becomes the side top gap STG. The distance between the main magnetic pole and the magnetic shield on the extended line on the short base edge is the side bottom gap SBG. The only differences from Embodiment 1 are in the main magnetic pole 61 and the magnetic shield 69. The other structures are the same, and the descriptions of the other structures are omitted for brevity.

According to the magnetic recording head and the magnetic disk storage device of this embodiment, the fringe magnetic field may be reduced without lowering the recording magnetic field.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A magnetic recording head, comprising:
a main magnetic pole adapted for generating a magnetic field for recording information on a magnetic disk;
a magnetic shield member adapted for suppressing spreading of a magnetic field output from the main magnetic pole through a non-magnetic insulation member;
a side top gap defined as a distance in a cross-track direction between the main magnetic pole and the magnetic shield member at a trailing end of the main magnetic pole on one side of the main magnetic pole;
a side bottom gap defined as a distance in the cross-track direction between the main magnetic pole and the magnetic shield member at a leading end of the main magnetic pole on one side of the main magnetic pole; and
a trailing gap defined as a distance in a trailing direction between the main magnetic pole and the magnetic shield member,
wherein the magnetic shield member is positioned on a sliding surface of the magnetic recording head and comprises:
a trailing portion positioned adjacent the trailing gap in the trailing direction; and
at least one side portion positioned adjacent the side bottom gap in the cross-track direction,
wherein the side top gap is less than two times the distance of the trailing gap, and
wherein the side bottom gap is larger than the side top gap.

2. The magnetic recording head as described in claim 1, wherein the side top gap and the trailing gap are about a same size.

3. The magnetic recording head as described in claim 1, wherein the side bottom gap is less than two times a pole width, wherein the pole width is defined as a width of the main magnetic pole at the trailing end thereof in the cross-track direction.

4. The magnetic recording head as described in claim 1, wherein the magnetic shield member is characterized by an aperture width of the magnetic shield member horizontally adjacent with the leading end of the main magnetic pole being larger than an aperture width of the magnetic shield member horizontally adjacent with the trailing end of the main magnetic pole.

5. The magnetic recording head as described in claim 1, wherein a sidewall of the magnetic shield member facing the main magnetic pole tapers away from a vertical line bisecting the main magnetic pole from a trailing end of the sidewall to a leading end of the sidewall and is characterized by an aperture width of the magnetic shield member horizontally adjacent with the leading end of the main magnetic pole being larger than an aperture width of the magnetic shield member horizontally adjacent with the trailing end of the main magnetic pole.

6. The magnetic recording head as described in claim 1, wherein the magnetic shield member has a non-uniform thickness across the cross-track direction characterized by an approximately L-shape as viewed normal to the sliding surface, and
wherein a width of a portion of the magnetic shield member laterally adjacent to the trailing end of the main magnetic pole is larger than a recording track width.

7. The magnetic recording head as described in claim 1, wherein the magnetic shield member has a non-uniform thickness characterized by a portion of the magnetic shield member on one side of the main magnetic pole being below the side bottom gap while another portion of the magnetic shield member on an opposite side of the main magnetic pole being above the side top gap, and
wherein a width of the magnetic shield member at the trailing end of the main magnetic pole is larger than a recording track width.

8. A magnetic data storage system, comprising:
at least one magnetic recording head as recited in claim 1;
a magnetic recording disk;
a drive mechanism for rotating the magnetic disk across the at least one magnetic recording head; and
a controller coupled to the at least one magnetic recording head for controlling operation of the at least one magnetic recording head.

9. A system, comprising:
a magnetic recording disk;
a magnetic recording head for recording information to the magnetic recording disk, the magnetic recording head comprising:
a main magnetic pole adapted for generating a magnetic field for recording information on a magnetic disk;
a magnetic shield member adapted for suppressing spreading of a magnetic field output from the main magnetic pole through a non-magnetic insulation member;
a side top gap defined as a distance in a cross-track direction between the main magnetic pole and the magnetic shield member at a trailing end of the main magnetic pole on one side of the main magnetic pole;
a side bottom gap defined as a distance in the cross-track direction between the main magnetic pole and the magnetic shield member at a leading end of the main magnetic pole on one side of the main magnetic pole; and
a trailing gap defined as a distance in a trailing direction between the main magnetic pole and the magnetic shield member,
wherein the magnetic shield member is positioned on a sliding surface of the magnetic recording head and comprises:
a trailing portion positioned adjacent the trailing gap in the trailing direction; and
two side portions positioned facing each side of the main magnetic pole in a cross-track direction,
wherein the side top gap is less than two times the distance of the trailing gap, and
wherein the side bottom gap is larger than the side top gap.

10. The system as described in claim 9, wherein the side top gap and the trailing gap are a same size.

11. The system as described in claim 9, wherein the side bottom gap is less than two times a pole width, wherein the pole width is defined as a width of the main magnetic pole at the trailing end thereof in the cross-track direction.

12. The system as described in claim 9, wherein the magnetic shield member is characterized by an aperture width of the magnetic shield member horizontally adjacent with the leading end of the main magnetic pole being larger than an aperture width of the magnetic shield member horizontally adjacent with the trailing end of the main magnetic pole.

13. The system as described in claim 9, wherein a sidewall of the magnetic shield member facing the main magnetic pole tapers away from a vertical line bisecting the main magnetic pole from a trailing end of the sidewall to a leading end of the sidewall and is characterized by an aperture width of the magnetic shield member horizontally adjacent with the leading end of the main magnetic pole being larger than an aperture width of the magnetic shield member horizontally adjacent with the trailing end of the main magnetic pole.

14. A system, comprising:
a magnetic recording disk;
a magnetic recording head for recording information to the magnetic recording disk, the magnetic recording head comprising:
a main magnetic pole adapted for generating a magnetic field for recording information on a magnetic disk;
a magnetic shield member adapted for suppressing spreading of a magnetic field output from the main magnetic pole through a non-magnetic insulation member;
a side top gap defined as a distance in a cross-track direction between the main magnetic pole and the magnetic shield member at a trailing end of the main magnetic pole on one side of the main magnetic pole;
a side bottom gap defined as a distance in the cross-track direction between the main magnetic pole and the magnetic shield member at a leading end of the main magnetic pole on one side of the main magnetic pole; and
a trailing gap defined as a distance in a trailing direction between the main magnetic pole and the magnetic shield member,
wherein the magnetic shield member is positioned on a sliding surface of the magnetic recording head and comprises:
a trailing portion positioned adjacent the trailing gap in the trailing direction; and
a side portion positioned facing one side of the main magnetic pole in the cross-track direction,
wherein the side top gap is less than two times the distance of the trailing gap, and
wherein the side bottom gap is larger than the side top gap.

15. The system as described in claim 14, wherein the side top gap and the trailing gap are a same size.

16. The system as described in claim 14, wherein the side bottom gap is less than two times a pole width, wherein the pole width is defined as a width of the main magnetic pole at the trailing end thereof.

17. The system as described in claim 14, wherein the magnetic shield member has a non-uniform thickness across the cross-track direction characterized by an approximately L-shape as viewed normal to the sliding surface, and
wherein a width of a portion of the magnetic shield member laterally adjacent to the trailing end of the main magnetic pole is larger than a recording track width.

18. The system as described in claim 14, wherein the magnetic shield member has a non-uniform thickness characterized by a portion of the magnetic shield member on one side of the main magnetic pole being below the side bottom gap while another portion of the magnetic shield member on an opposite side of the main magnetic pole being above the side top gap, and
wherein a width of the magnetic shield member at the trailing end of the main magnetic pole is larger than a recording track width.
